(19) United States
(12) Patent Application Publication
(10) Pub. No.: US 2024/0253752 A1
(43) Pub. Date: Aug. 1, 2024

(54) WATER VEHICLE

(71) Applicant: KAWASAKI MOTORS, LTD., Akashi-shi (JP)

(72) Inventors: Yuki NAKAMURA, Akashi-shi (JP); Toshio ARAKI, Akashi-shi (JP)

(21) Appl. No.: 18/161,796

(22) Filed: Jan. 30, 2023

(51) Int. Cl. B63B 79/40; B63B 34/10; B63B 34/60; B63B 49/00; B63B 79/10

(52) U.S. Cl. CPC B63B 79/40; B63B 34/10; B63B 34/60; B63B 49/00; B63B 79/10

(57) ABSTRACT

A water vehicle includes: a water vehicle body; a control target mounted on the water vehicle body and controlled to operate the water vehicle body; and processing circuitry configured to acquire requested values used to operate the water vehicle body and generate, based on the requested values, command values to be output to the control target. The processing circuitry switches a control mode between a towing mode in which the water vehicle tows a towed target and a non-towing mode in which the water vehicle does not tow the towed target. When the control mode is the towing mode, the processing circuitry generates, based on the requested value, a second command value that is the command value different from a first command value that is the command value generated based on the requested value when the control mode is the non-towing mode.

### BACKGROUND OF THE INVENTION

### Field of the Invention

One aspect of the present disclosure relates to a water vehicle, such as a personal watercraft.

### Description of the Related Art

In sports on water, such as wakeboarding and parasailing, a person is towed by a water vehicle, such as a personal watercraft disclosed in U.S. Pat. No. 5,850,803 A. Moreover, entertainment in which play equipment, such as a recreational boat, is towed by the water vehicle is widely enjoyed.

### SUMMARY OF THE INVENTION

A water vehicle according to one aspect of the present disclosure includes: a water vehicle body; a control target mounted on the water vehicle body and controlled to operate the water vehicle body; and processing circuitry configured to acquire requested values used to operate the water vehicle body and generate, based on the requested values, command values to be output to the control target. The processing circuitry switches a control mode between a towing mode in which the water vehicle tows a towed target and a non-towing mode in which the water vehicle does not tow the towed target. When the control mode is the towing mode, the processing circuitry generates, based on the requested value, a second command value that is the command value different from a first command value that is the command value generated based on the requested value when the control mode is the non-towing mode.

A water vehicle according to another aspect of the present disclosure includes: a water vehicle body; a fixture which extends upward from the water vehicle body and to which one end portion of an extending structure used to tow the towed target is fixed; and a seat which is located in front of the fixture and on which a rider is seated. A height of an upper end of the fixture is higher than a height of an uppermost surface of the seat.

A water vehicle according to yet another aspect of the present disclosure includes: a water vehicle body; a traveling state detection sensor that detects a traveling state of the water vehicle; an informer mounted on the water vehicle body; and processing circuitry configured to control the informer. The processing circuitry switches a control mode between a towing mode in which the water vehicle tows a towed target and a non-towing mode in which the water vehicle does not tow the towed target. When the control mode is the towing mode, the processing circuitry determines whether or not the traveling state detected by the traveling state detection sensor satisfies a predetermined warning condition. When the processing circuitry determines that the warning condition is satisfied, the processing circuitry outputs predetermined warning information through the informer.

The above object, other objects, features, and advantages of the present disclosure will be made clear by the following detailed explanation of preferred embodiments with reference to the attached drawings.

### BRIEF DESCRIPTION OF THE DRAWINGS

FIG. 1 is a diagram showing that a recreational boat is towed by a personal watercraft according to Embodiment 1.

FIG. 2 is a partial cutaway side view of the personal watercraft according to Embodiment 1.

FIG. 3 is a top view of the personal watercraft shown in FIG. 1.

FIG. 4 is a block diagram of a control system of the personal watercraft shown in FIG. 1.

FIG. 5 is a flowchart for explaining operation processing of a controller in the personal watercraft according to Embodiment 1.

FIG. 6 is a graph for explaining towing traveling processing.

FIG. 7 is a flowchart for explaining falling informing processing.

FIG. 8 is a flowchart for explaining position warning processing.

FIG. 9 is a graph for explaining another towing traveling processing different from the processing shown by the graph in FIG. 6.

FIG. 10 is a flowchart for explaining operation processing of the controller in the personal watercraft according to Embodiment 2.

FIG. 11 is a top view of the personal watercraft including a cover according to Modified Example.

### DESCRIPTION OF THE PREFERRED EMBODIMENTS

Hereinafter, embodiments will be described with reference to the drawings.

### Embodiment 1

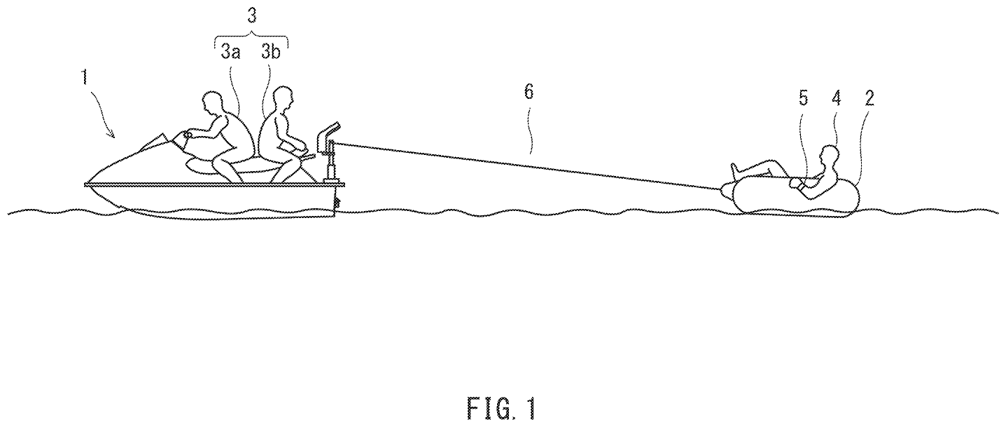

FIG. 1 is a diagram showing that a recreational boat 2 is towed by a personal watercraft 1 according to Embodiment 1. In the following description, the personal watercraft may be abbreviated as a PWC. At least one occupant 3 is on the PWC 1. As shown in FIG. 1, in this example, two occupants 3 are on the PWC 1. One of the two occupants 3 is a rider 3a who operates and drives the PWC 1, and the other occupant 3 is a rear-side monitoring person 3b who monitors a rear side of the PWC 1. The rear-side monitoring person 3b monitors a towed state of a below-described towed target.

At least one person (hereinafter also referred to as a participant) 4 who has participated in recreation is on the recreational boat 2. The recreational boat 2 is, for example, a non-powered rubber boat. The participant 4 wears a life jacket. Moreover, the participant 4 wears a communicator 5 that can perform wireless communication. The communicator 5 may be of a wearable type, such as a smart watch, or may be attached to the life jacket worn by the participant 4.

The PWC 1 and the recreational boat 2 are connected to each other through a rope 6 that is an extending structure extending rearward from the PWC 1. The PWC 1 travels on water to tow the recreational boat 2 and the participant 4 on the recreational boat 2. With this, the participant 4 can enjoy towing activities.

Hereinafter, the recreational boat 2 towed by the PWC 1 and the participant 4 on the recreational boat 2 may be collectively called the “towed target.” A person towed in the towed target, i.e., the participant 4 may also be called a “towed person 4.” The towed target may differ depending on the types of towing sports and towing activities (hereinafter may be simply referred to as “towing”). For example, in parasailing using the PWC 1, the towed target includes: a parachute fixed to an end portion of the extending structure; and a person suspended by the parachute. For example, in wakeboarding using the PWC 1, the towed target includes a person who holds the end portion of the extending structure.

In order that the towed person 4 enjoys various kinds of towing, the rider 3a of the PWC 1 is required to have operation skill. As described below, the PWC 1 of the present embodiment assists the driving of the PWC 1 by the rider 3a so as to perform traveling suitable for the towing.

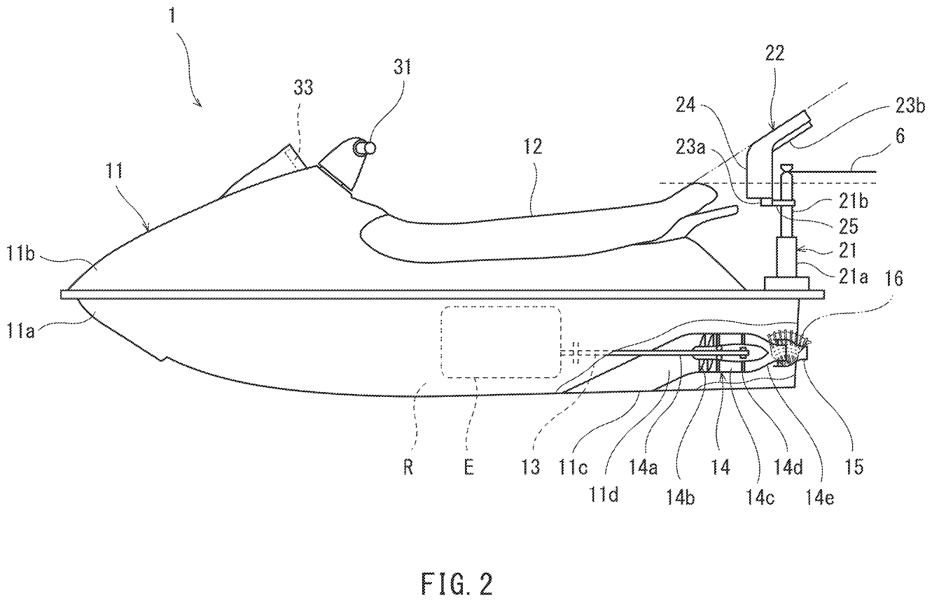

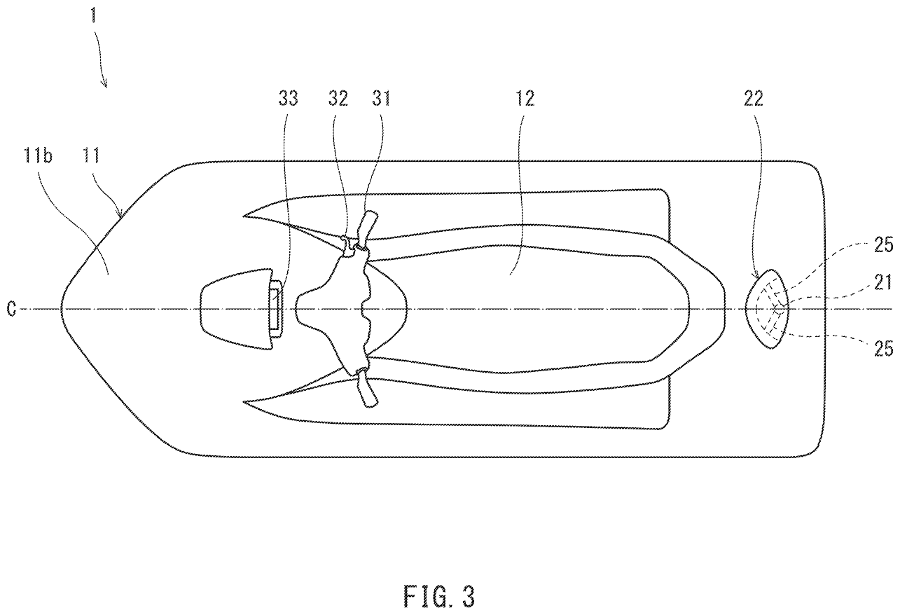

FIG. 2 is a side view of the PWC 1 which is partially shown as a sectional view. FIG. 3 is a top view of the personal watercraft shown in FIG. 1. As shown in FIG. 2, the PWC 1 includes a water vehicle body 11, and the water vehicle body 11 includes a hull 11a and a deck 11b that covers the hull 11a from above. A seat 12 on which a user is seated is attached to the deck 11b. An upper surface of a rear end portion of the seat 12 rises diagonally upward. A prime mover room R is in the water vehicle body 11. A prime mover E is accommodated in the prime mover room R of the water vehicle body 11. In the present embodiment, the prime mover E is an internal combustion engine. An output shaft of the prime mover E is connected to a propeller shaft 13 extending rearward.

A water jet pump 14 is located at a rear portion of the hull 11a. The water jet pump 14 includes: a pump shaft 14a coupled to a rear end portion of the propeller shaft 13; an impeller 14b fixed to the pump shaft 14a; a stator vane 14c located behind the impeller 14b; a pump casing 14d covering the impeller 14b from a radially outer side; and a pump nozzle 14e directed to a rear side of the water vehicle body 11.

A water intake port 11c is open on a bottom portion of the hull 11a. The water intake port 11c communicates with the pump casing 14d through a water intake passage 11d. A steering nozzle 15 is connected to the pump nozzle 14e of the water jet pump 14 so as to be swingable in a left-right direction. A reverse bucket 16 is attached to the hull 11a. The reverse bucket 16 is pivotally supported by the hull 11a so as to be turnable between an advance position at which the reverse bucket 16 covers an ejection port of the steering nozzle 15 from behind to reverse ejected water from the steering nozzle 15 toward a front direction and a retreat position at which the ejection port of the steering nozzle opens toward a rear direction. When the reverse bucket 16 moves to the advance position, the PWC 1 moves rearward. When the reverse bucket 16 moves to the advance position, and the steering nozzle 15 swings to the left or the right, the PWC 1 moves diagonally rearward.

The PWC 1 pressurizes and accelerates the water, taken in through the water intake port 11c of the bottom portion of the hull 11a, by rotational force of the impeller 14b of the water jet pump 14 driven by the prime mover E. The flow of this water is straightened by the stator vane 14c and is ejected rearward from the pump nozzle 14e through the steering nozzle 15. Thus, propulsive force is generated. The PWC is not limited to a watercraft that is propelled on water by jet water flow generated by the water jet pump. The PWC may be a boat that is propelled on water by the rotation of a propeller.

A pole 21 is located behind the seat 12. One end portion of the rope 6 used to tow the towed target is fixed to the pole 21. The pole 21 is one example of a fixture, and the rope 6 is one example of the extending structure. As shown in FIG. 3, the pole 21 is located on a center plane C of the water vehicle body 11 which divides the water vehicle body 11 into left and right parts.

The pole 21 is fixed to a rear portion of the deck 11b. As shown in FIG. 2, the pole 21 extends upward from an upper surface of the deck 11b. In the present embodiment, the pole 21 has an extensible structure. Specifically, the pole 21 includes: a fixed portion 21a fixed to the deck 11b; and a movable portion 21b supported by the fixed portion 21a so as to be slidable in an upper-lower direction. The movable portion 21b can be fixed relative to the fixed portion 21a at a position where the entire length of the pole 21 is large, i.e., the pole 21 is in an extended state, or at a position where the entire length of the pole 21 is small, i.e., the pole 21 is in a contracted state. When the towing is not performed, the pole 21 is normally in the contracted state. When the towing is performed, the user slides the movable portion 21b upward and fixes the movable portion 21b relative to the fixed portion 21a. Thus, the pole 21 is set to the extended state. For example, the pole 21 may be detachable from the water vehicle body 11. To be specific, for example, the pole 21 may be attached to the water vehicle body 11 when the PWC 1 performs the towing, and may be detached from the water vehicle body 11 in the other cases.

One end portion of the rope 6 is attached to an upper end portion of the pole 21. In FIG. 2, the height of an uppermost surface of the seat 12 is shown by a broken line. As shown in FIG. 2, at least when the pole 21 is in the extended state, the height of an upper end of the pole 21 is higher than the height of the uppermost surface of the seat 12. Therefore, the rope 6 can be extended from a position higher than the seat 12. On this account, the rope 6 can be extended from a position suitable for water sports and sky sports. When the pole 21 is in the contracted state, the height of the upper end of the pole 21 may be lower than the height of the uppermost surface of the seat 12.

Moreover, a cover 22 that covers the pole 21 from a front side and an upper side is located behind the seat 12. In a front view of the PWC 1, the cover 22 and at least the upper end portion of the pole 21 overlap each other. Moreover, in a top view of the PWC 1, the cover 22 and the pole 21 overlap each other.

Moreover, as shown in FIG. 2, when the PWC 1 is viewed in the left-right direction, the cover 22 and the pole 21 do not overlap each other. Therefore, it is possible to reduce a possibility that the rope 6 contacts the cover 22 when the PWC 1 turns.

In the present embodiment, the cover 22 includes: a cover main body 23 supported by the water vehicle body 11; and a pad 24 located on a surface of the cover main body 23 which faces forward. The cover main body 23 has certain rigidity. For example, the cover main body 23 is made of metal. In the present embodiment, the cover main body 23 includes a front plate portion 23a and an upper plate portion 23b. The front plate portion 23a is located in front of the pole 21 and has a circular-arc shape in a top view. The upper plate portion 23b is connected to an upper end portion of the front plate portion 23a and is located above the pole 21. As shown in FIG. 2, the upper plate portion 23b extends diagonally rearward from the upper end portion of the front plate portion 23a. As shown by a two-dot chain line in FIG. 2, in a side view, a surface, facing obliquely upward, of the upper plate portion 23b when the pole 21 is in the extended state is located on an extended line of the upper surface of the rear end portion of the seat 12 rising obliquely upward. The pad 24 is attached to a surface of the cover main body 23 which is opposite to a surface facing the pole 21. To be specific, the pad 24 is attached to a part of a surface of the front plate portion 23a which faces forward and an upper surface of the upper plate portion 23b. The pad 22b is lower in rigidity than the cover main body 23 and has a cushioning property.

In the present embodiment, the cover 22 is fixed to the pole 21. Specifically, as shown in FIG. 3, the movable portion 21b of the pole 21 and the cover 22 are connected to each other by one or more supports 25. For example, the support 25 is a rod-shaped body extending in a horizontal direction. The cover 22 is supported by the pole 21 through the supports 25. Therefore, the pole 21 and the cover 22 are integrally attachable to and detachable from the water vehicle body 11. The cover 22 does not have to be supported by the pole 21. For example, the support that supports the cover 22 may be directly fixed to the deck 11b, not the pole 21.

A bar-shaped handle 31 supported by the deck 11b so as to be turnable is located above a front portion of the deck 11b. As shown in FIG. 3, the handle 31 includes an accelerator lever 32 as an accelerator operator. The accelerator lever may also be called a throttle lever. The accelerator lever 32 is located at a right side of the center plane C of the water vehicle body 11 which divides the water vehicle body 11 into left and right parts. The flow rate of air supplied to the prime mover E from an outside of the water vehicle body 11 is adjusted by operating the accelerator lever 32. As a result, the rotational force of the impeller 14b of the water jet pump 14 changes.

Moreover, the handle 31 is turnable relative to the deck 11b. When the rider 3a turns the handle 31 to the left or the right, the steering nozzle 15 swings to the left or the right in association with the turning operation of the rider 3a. As a result, the proceeding direction of the PWC 1 is changed.

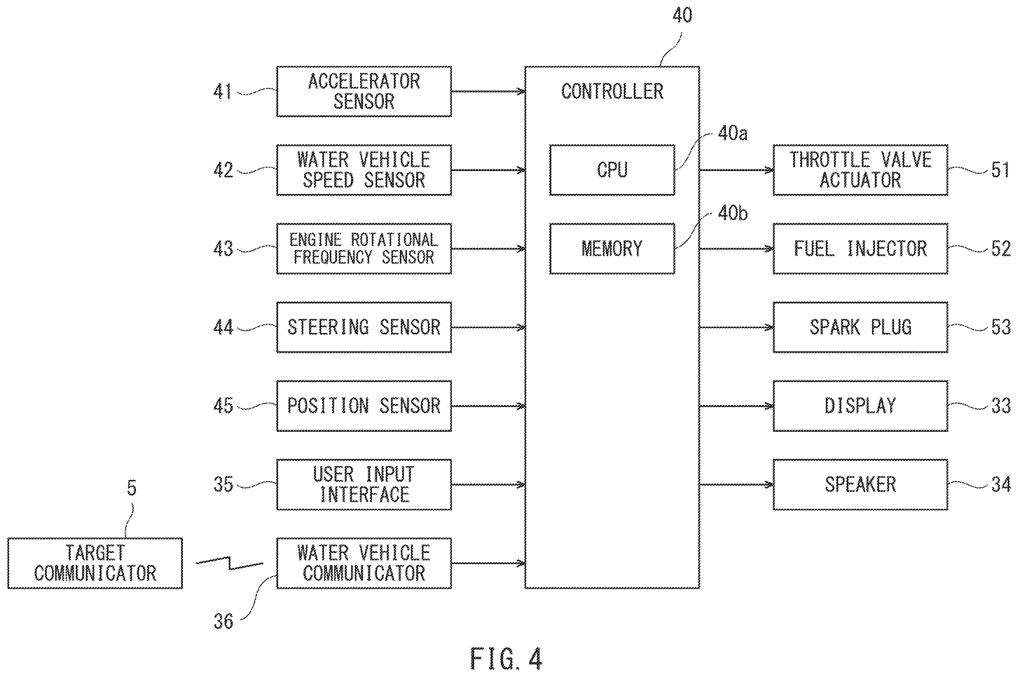

A display 33 is located in front of the handle 31. As described below, the display 33 may display falling information and warning information. The display 33 may also display water vehicle body speed information, oil remaining amount information, battery remaining amount information, and the like. Moreover, a speaker 34 (see FIG. 4) is mounted on the water vehicle body 11. Each of the display 33 and the speaker 34 is one example of an informer.

FIG. 4 is a block diagram of a control system of the PWC 1 shown in FIG. 1. A controller 40 that controls the prime mover E as the internal combustion engine and various devices is mounted on the water vehicle body 11. The controller 40 includes a CPU 40a and a memory 40b. The CPU 40a is a central processing unit. The memory 40b may include a RAM and a ROM. The memory 40b may include a hard disk, a flash memory, or a combination thereof. The memory 40b stores various programs. A configuration in which the CPU 40a executes a program read by the memory 40b is one example of processing circuitry. The controller 40 does not have to be configured as a single control unit and may be configured by plural control units.

As shown in FIG. 4, an accelerator sensor 41, a water vehicle speed sensor 42, an engine rotational frequency sensor 43, a steering sensor 44, and a position sensor 45 are connected to the controller 40.

The accelerator sensor 41 detects an acceleration requested amount requested by the rider 3a of the PWC 1. Specifically, the accelerator sensor 41 detects an operation amount of the accelerator lever 32.

The water vehicle speed sensor 42 detects a traveling speed of the water vehicle body 11. For example, the water vehicle speed sensor 42 may be: a sensor that estimates a water vehicle speed from an accumulated amount of the engine rotational frequency in a certain latest period of time; a sensor that calculates the water vehicle speed from the positional displacement of the water vehicle body 11 which is detected by a GPS sensor; or a water flow speed sensor that calculates the water vehicle speed from a rotational frequency of a water wheel that rotates by water flow around the water vehicle body 11, the rotational frequency being detected by a rotational frequency sensor.

The engine rotational frequency sensor 43 is a sensor that detects the rotational frequency of the output shaft of the prime mover E. The steering sensor 44 detects a steering angle of the handle 31.

The steering sensor 44 may determine at least whether or not the steering angle of the handle 31 is a threshold or more. For example, the steering sensor 44 may be a switch that outputs an ON signal when the steering angle is the threshold or more, and stops the output of the ON signal when the steering angle is less than the threshold.

The position sensor 45 is a sensor that detects current position coordinates of the PWC 1. The position sensor 45 may be a satellite positioning sensor, such as a GPS sensor. The current position coordinates of the PWC 1 may be obtained by calculation based on: a travel distance calculated from the traveling speed detected by the water vehicle speed sensor 42; and a travel direction calculated from acceleration detected by, for example, an IMU.

A user input interface 35 is an interface that receives operation of a user, such as the rider 3a, and inputs information of the operation of the user to the controller 40. The user input interface 35 may be a touch panel of the display 33 or a manipulation element, such as a button or a lever which is separated from the display. The user input interface may be a microphone through which information pronounced by the user is input to the controller 40.

Moreover, a communicator 36 is connected to the controller 40. The communicator 36 directly communicate with the communicator 5 of the towed person 4 through wireless communication. For example, the communicator 36 and the communicator 5 may perform wireless communication through near field communication, such as Bluetooth.

The prime mover E includes a throttle valve actuator 51, a fuel injector 52, and a spark plug 53. The throttle valve actuator 51, the fuel injector 52, and the spark plug 53 are connected to the controller 40. The throttle valve actuator 51 drives a throttle valve to adjust a throttle valve opening degree of a throttle device communicating with an intake port of the prime mover E. The fuel injector 52 performs fuel injection to intake air of the prime mover E. The spark plug 53 ignites a fuel-air mixture in a combustion chamber of the prime mover E. The prime mover E is controlled by the controller 40.

The controller 40 acquires a requested value for operating the water vehicle body 11. In the present specification, acquiring information such as the requested value may denote receiving information or calculating information. In the present embodiment, the requested value is a detected value detected by the accelerator sensor 41. The CPU 40a of the controller 40 is configured to: receive the requested value that is the detected value received from the accelerator sensor 41; and based on the received requested value, generate a command value to be output to the prime mover E.

The number of command values generated by the controller 40 may be plural. To be specific, the command value may be sent to one of the throttle valve actuator 51, the fuel injector 52, and the spark plug 53 in the prime mover E, or the command values may be sent to two or more out of the throttle valve actuator 51, the fuel injector 52, and the spark plug 53 in the prime mover E. The output of the prime mover E that is the internal combustion engine is controlled by controlling the throttle valve actuator 51, the fuel injector 52, and the spark plug 53 in the prime mover E. The prime mover E corresponds to a control target. More specifically, the throttle valve actuator 51, the fuel injector 52, or the spark plug 53 in the prime mover E corresponds to the control target.

The display 33 and the speaker 34 are connected to the controller 40. The display 33 may be a display device, such as a liquid crystal display, an organic EL display, an AR (Augmented Reality) display, or a head mount display, which displays a warning image for the rider 3a. The speaker 34 may be integrated with the water vehicle body 11 or may be separated from the water vehicle body 11.

### Control Flow

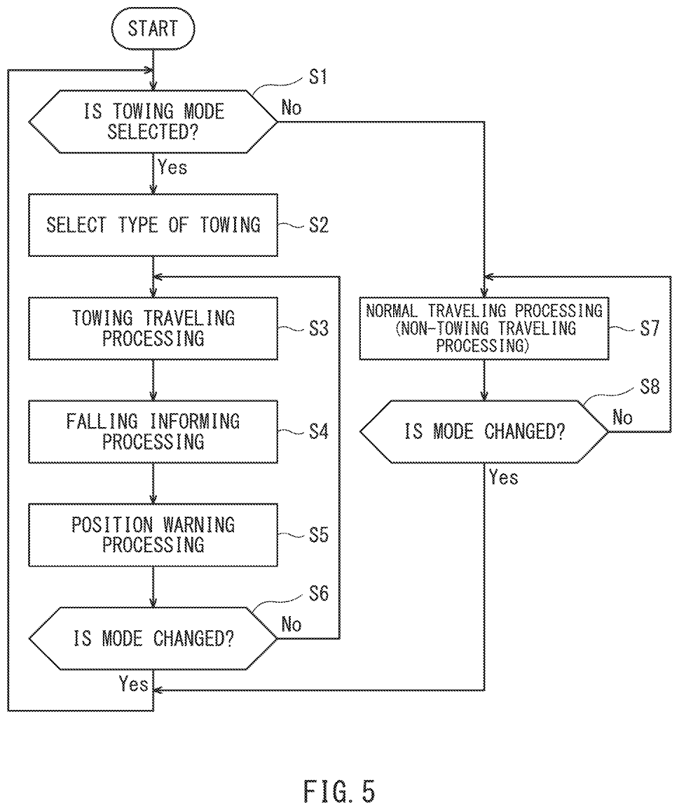

FIG. 5 is a flowchart for explaining operation processing of the controller 40 in the PWC 1 according to Embodiment 1. According to the PWC 1 of the present embodiment, the user, such as the rider 3a, can select a control mode from plural modes. For example, the CPU 40a makes the display 33 display a mode selection screen image in which a normal mode or a towing mode is selected as the control mode. The CPU 40a switches the control mode between the normal mode and the towing mode in accordance with the operation of the rider 3a with respect to the user input interface 35. The CPU 40a determines whether or not the towing mode has been selected as the control mode (Step S1).

The normal mode is a mode which realizes normal traveling in which the towed target is not towed. The normal mode may also be called a non-towing mode. The towing mode is a mode which realizes traveling suitable for the towing of the towed target.

When the CPU 40a determines that the towing mode has not been selected, i.e., when the CPU 40a determines that the normal mode has been selected (No in Step S1), the CPU 40a executes normal traveling processing (Step S7). The normal traveling processing may also be called non-towing traveling processing. Details of the normal traveling processing will be described later together with the towing traveling processing.

The normal traveling processing is maintained until the control mode is changed by the operation of the rider 3a with respect to the user input interface 35 (No in Step S8). When the control mode is changed by the operation of the rider 3a with respect to the user input interface 35 (Yes in Step S8), the CPU 40a returns to Step S1.

In Step S1, when the CPU 40a determines that the towing mode has been selected (Yes in Step S1), the CPU 40a selects the type of the towing (Step S2). By the selection of the type of the towing, control suitable for the type of the towing can be realized as described below. In the present embodiment, when the CPU 40a determines that the towing mode has been selected, the CPU 40a makes the display 33 display plural types of the towing such that the types of the towing are selectable. The user can select one of the displayed types of the towing through the user input interface 35. Examples of the types of the towing include recreational boating, wakeboarding, and parasailing.

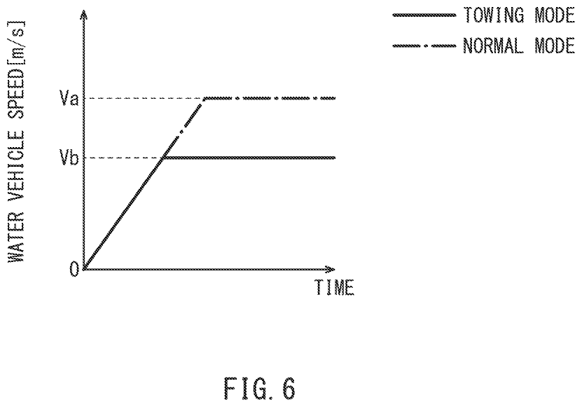

After the type of the towing is selected and determined, the CPU 40a executes the towing traveling processing (Step S3). The normal traveling processing in Step S7 and the towing traveling processing in Step S3 will be specifically described with reference to FIG. 6.

FIG. 6 is a graph showing a change in water vehicle speed in the normal mode and a change in water vehicle speed in the towing mode. Specifically, FIG. 6 shows a relation between an elapsed time and the water vehicle speed when the rider 3a operates the accelerator lever 32 to, for example, an upper limit with the PWC 1 in a stop state and maintains such operation. To be specific, FIG. 6 shows the change in water vehicle speed in the normal mode and the change in water vehicle speed in the towing mode when the operation amount of the accelerator lever 32 is the same between the normal mode and the towing mode, in other words, when the requested value is the same between the normal mode and the towing mode. In FIG. 6, the change in water vehicle speed in the normal mode is shown by a one-dot chain line, and the change in water vehicle speed in the towing mode is shown by a solid line.

In both the normal mode and the towing mode, the CPU 40a generates a command value for controlling the prime mover E, based on the requested value that is the detected value detected by the accelerator sensor 41. In the following description, the command value generated by the CPU 40a in the normal mode is referred to as a “first command value,” and the command value generated by the CPU 40a in the towing mode is referred to as a “second command value.” When the CPU 40a generates the command values in the normal mode and the towing mode based on the same requested value, these command values may be different from each other.

As shown in FIG. 6, an increase rate of the water vehicle speed with respect to the same requested value, i.e., the acceleration of the water vehicle is the same between the normal mode and the towing mode. However, the maximum speed of the water vehicle is different between the normal mode and the towing mode. A second set speed Vb that is the maximum speed set for the towing mode is lower than a first set speed Va that is the maximum speed set for the normal mode.

In the normal traveling processing, the maximum speed of the PWC 1 is limited to the preset first set speed Va. To be specific, in the normal mode, the CPU 40a generates the command value to be output to the prime mover E as the control target, i.e., the first command value to be output to the throttle valve actuator 51, the fuel injector 52, and the spark plug 53 such that the speed detected by the water vehicle speed sensor 42 becomes the preset first set speed Va or less. In other words, the command value to be output to the prime mover E is limited such that the maximum speed does not exceed the first set speed Va.

In the towing traveling processing, the maximum speed of the PWC 1 is limited to the preset second set speed Vb. To be specific, in the towing mode, the CPU 40a generates the command value to be output to the prime mover E, i.e., the second command value to be output to the throttle valve actuator 51, the fuel injector 52, and the spark plug 53 such that the speed detected by the water vehicle speed sensor 42 becomes the preset second set speed Vb or less. In other words, the command value to be output to the prime mover E is limited such that the maximum speed does not exceed the second set speed Vb. The second set speed Vb is lower than the first set speed Va. To be specific, in the normal mode (non-towing mode) as the control mode, even after the water vehicle speed has reached the second set speed Vb, the CPU 40a outputs the first command value based on the acceleration requested amount so as to increase the water vehicle speed. However, in the towing mode as the control mode, even when the CPU 40a receives the acceleration requested amount after the water vehicle speed has reached the second set speed Vb, the CPU 40a does not increase the water vehicle speed and maintains the water vehicle speed at the second set speed Vb. In other words, in the towing mode, the CPU 40a generates the second command value such that the maximum speed of the PWC 1 becomes lower than the maximum speed when the control mode is the non-towing mode. Therefore, the maximum speed of the PWC 1 in the towing mode is made lower than that in the normal mode.

In the present embodiment, a reduced amount of the second command value from the first command value, in other words, a difference between the command values which corresponds to a difference (=Va−Vb) between the maximum speeds corresponds to the type of the towing selected in Step S2. The memory 40b stores the second set speeds Vb that are the maximum speeds suitable for the respective types of the towing, such as recreational boating, wakeboarding, and parasailing. In the towing traveling processing, the CPU 40a generates the command value to be output to the prime mover E such that the speed detected by the water vehicle speed sensor 42 becomes not more than the second set speed Vb corresponding to the type of the towing selected in Step S2. To be specific, the reduced amount of the second command value from the first command value is determined by the operation of the rider 3a with respect to the user input interface 35 in Step S2.

When the control mode is the towing mode, the CPU 40a executes the towing traveling processing, and in addition, below-described falling informing processing and position warning processing (Steps S4 and S5).

The towing traveling processing is maintained until the control mode is changed by the operation of the rider 3a with respect to the user input interface 35 (No in Step S6). When the control mode is changed by the operation of the rider 3a with respect to the user input interface 35 (Yes in Step S6), the CPU 40a returns to Step S1.

In the normal traveling processing in Step S7 described above, the CPU 40a limits the maximum speed of the PWC 1 to the first set speed Va. However, the first set speed Va may not be especially set. To be specific, in the normal traveling processing, control of limiting the water vehicle speed is not executed. Even in this case, when the control mode is the towing mode, the CPU 40a generates based on the requested value the second command value that is the command value different from the first command value that is the command value generated based on the same requested value when the control mode is in the non-towing mode. For example, in the normal traveling processing, in some cases, the CPU 40a generates the command value in accordance with an acquired certain requested value such that the speed detected by the water vehicle speed sensor 42 exceeds a predetermined speed (the above-described second set speed Vb). Even in such a case, in the towing traveling processing, the CPU 40a generates the second command value in accordance with the same certain requested value such that the speed detected by the water vehicle speed sensor 42 becomes a predetermined speed (the above-described second set speed Vb) or less. To be specific, in the towing traveling processing, the command value to be generated is limited.

### Falling Informing Processing

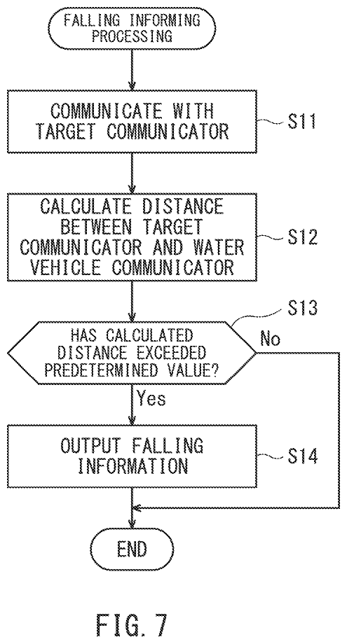

Next, the falling informing processing in Step S4 will be described with reference to FIG. 7. FIG. 7 is a flowchart for explaining the falling informing processing. The falling informing processing is processing which informs the rider 3a that the towed target is not being towed any more.

In the falling informing processing, the CPU 40a controls the communicator 36 (hereinafter, a water vehicle communicator 36) to communicate with the communicator 5 (hereinafter a target communicator 5) of the towed target (Step S11).

The CPU 40a calculates a distance between the water vehicle communicator 36 and the target communicator 5 based on a signal received from the target communicator 5 (Step S12). For example, the distance between the water vehicle communicator 36 and the target communicator 5 is calculated in such a manner that the CPU 40a estimates the distance by using, for example, the strength, phase, and the like of the signal from the target communicator 5.

The CPU 40a determines whether or not the calculated distance has exceeded a predetermined value (Step S13). By this determination, whether or not the person included in the towed target is not being towed any more is determined.

When the CPU 40a determines that the towed target is not being towed any more, the CPU 40a outputs the determination result through the informer. Specifically, when the CPU 40a determines that the distance calculated in Step S12 has exceeded the predetermined value (Yes in Step S13), the CPU 40a outputs falling information indicating that the towed person 4 has fallen from the recreational boat 2 (Step S14). The predetermined value is set to a value based on which it can be determined that the towed person 4 has fallen from the recreational boat 2. For example, the predetermined value is a value obtained by adding several meters to the entire length of the rope 6 that is the extending structure.

The falling information is output through both the display 33 and the speaker 34. However, the falling information may be output through the display 33 or the speaker 34. For example, the falling information is information that informs the rider 3a that the towed person 4 is not being towed any more. The mode of the output of the falling information is not especially limited and may be such a mode that the rider 3a can recognize that the towed person 4 is not being towed any more. For example, the falling information displayed on the display 33 may be displayed as information including blinking, color change, enlargement, brightness change, text addition, mark addition, or any combination thereof. For example, the falling information output from the speaker 34 may be a voice message indicating the determination result of the towed state or may be a buzzer sound.

When the CPU 40a determines whether or not the calculated distance has exceeded the predetermined value (No in Step S13), the CPU 40a terminates the falling informing processing.

The CPU 40a determines the towed state of the towed target based on the signal received from the target communicator 5. However, the method of determining the towed state of the towed target is not limited to this. For example, the CPU 40a may determine the towed state of the towed target based on a communication state between the water vehicle communicator and the target communicator. Specifically, when the CPU 40a does not receive the signal from the target communicator 5, the CPU 40a may determine that the person who wears the target communicator 5 and is included in the towed target is not being towed any more. Moreover, an image sensor that takes an image of the towed target may be mounted on the water vehicle body 11, and the CPU 40a may determine based on image information taken by the image sensor whether or not the towed target is not being towed any more. Furthermore, a load sensor that detects a load by which the extending structure pulls the fixture may be mounted on the water vehicle body 11, and the CPU 40a may determine based on load information detected by the load sensor whether or not the towed target is not being towed any more.

### Position Warning Processing

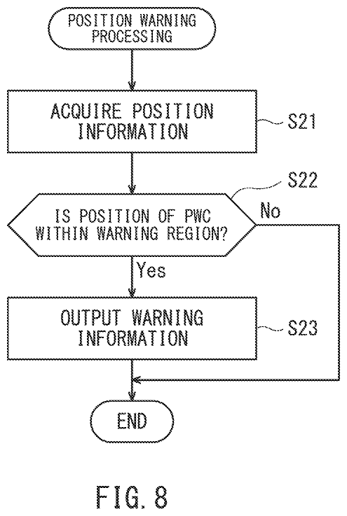

Next, the position warning processing in Step S5 will be described with reference to FIG. 8. FIG. 8 is a flowchart for explaining the position warning processing. The position warning processing is processing which assists the rider 3a such that traveling is performed in a region suitable for the towing.

In the position warning processing, the CPU 40a acquires a geographical position of the PWC 1 (Step S21). Specifically, the CPU 40a receives the current position coordinates of the PWC 1 which are detected by the position sensor 45.

The CPU 40a determines whether or not a current position of the PWC 1 is within a predetermined warning region (Step S22). When the CPU 40a determines that the current position of the PWC 1 is within the warning region (Yes in Step S22), the CPU 40a outputs predetermined warning information through the informer (Step S23).

The warning region is prestored in the memory 40b as a region unsuitable for the towing or a region in which attention is necessary at the time of the towing. For example, it is desirable that the water vehicle body 11 do not approach a region where towing sports and towing activities are prohibited and a region where artificial objects such as buildings or natural objects such as rocks exist. By setting the warning regions around the above regions, the rider 3a can be warned that the water vehicle body 11 does not enter the region where the towing is prohibited and the region where obstacles or the like may exist.

The warning information is output through both the display 33 and the speaker 34. However, the warning information may be output through the display 33 or the speaker 34. For example, the warning information is information indicating that the water vehicle body 11 is located in the warning region. The mode of the output of the warning information is not especially limited and may be such a mode that the rider 3a can recognize that the water vehicle body 11 is located in the warning region. For example, the warning information displayed on the display 33 may be displayed as information including blinking, color change, enlargement, brightness change, text addition, mark addition, or any combination thereof. The warning information may be map information indicating a current geographical position of the water vehicle body 11. For example, the warning information output from the speaker 34 may be a voice message indicating that the water vehicle body 11 has entered the warning region or may be a buzzer sound.

When the CPU 40a determines that the current position of the PWC 1 is not within the warning region (No in Step S22), the CPU 40a terminates the position warning processing.

In the present embodiment, the warning region may correspond to the type of the towing selected in Step S2 of FIG. 5. For example, the memory 40b may store the warning regions for the respective types of the towing, such as recreational boating, wakeboarding, and parasailing, and the determination in Step S22 may be performed by using the warning region corresponding to the type of the towing selected in Step S2.

According to the above-described configuration, in the towing mode, the CPU 40a generates the second command value such that the maximum speed of the PWC 1 becomes lower than the maximum speed when the control mode is the non-towing mode. Therefore, the maximum speed of the PWC 1 in the towing mode is made lower than that in the normal mode, and the PWC 1 can be controlled so as to perform operation suitable for the towing.

Moreover, in the present embodiment, the control mode is switched between the towing mode and the non-towing mode based on the operation of the rider 3a with respect to the user input interface 35. Therefore, the rider 3a can manually switch the control mode between the towing mode and the non-towing mode.

Moreover, in the present embodiment, by the communication between the water vehicle communicator 36 and the target communicator 5, the CPU 40a determines whether or not the person included in the towed target is not being towed any more. Therefore, control when the towed target is not being towed any more is easily executed.

Moreover, in the present embodiment, when the CPU 40a determines that the person included in the towed target is not being towed any more, that the towed person 4 has fallen from the recreational boat 2 is output through the display 33 and the speaker 34. Therefore, it is possible to quickly inform the rider 3a that the towed target is not being towed any more.

Moreover, in the present embodiment, the height of the upper end of the pole 21 that is the fixture is higher than the height of the uppermost surface of the seat 12. Therefore, the rope 6 can be extended from a position of the pole 21 which is higher than the seat 12. On this account, the rope 6 can be extended from a position suitable for water sports and sky sports.

Moreover, in the present embodiment, since the pole 21 is covered with the cover 22, the pole 21 that is the fixture can be protected. Furthermore, since the cover 22 includes the pad 24, impact generated when an object or a person collides with the cover 22 can be absorbed by the pad 24.

Moreover, in the present embodiment, the reduced amount of the second command value from the first command value is changed by the operation of the rider 3a with respect to the user input interface 35. Therefore, the control of the PWC 1 can be set such that the PWC 1 performs operation suitable for the user.

Moreover, in the present embodiment, when the CPU 40a determines that the current position of the PWC 1 is within the warning region, the warning information is output through the display 33 and the speaker 34. Therefore, it is possible to quickly inform the rider 3a that the water vehicle body is located in, for example, a region where towing sports and towing activities are inhibited or a region where attention is necessary.

### Other Control Methods in Tow Mode

The control method in the towing mode may be different from the above-described method and may vary.

For example, when the control mode is the towing mode, the CPU 40a generates based on the requested value the second command value that is the command value smaller than the first command value that is the command value generated based on the same requested value when the control mode is the non-towing mode. However, such control does not have to be performed. The command value generated based on the requested value may be different between the towing mode and the non-towing mode. For example, when the control mode is the towing mode, the CPU 40a may generate based on the requested value the second command value that is the command value larger than the first command value that is the command value generated based on the same requested value when the control mode is the non-towing mode.

For example, the CPU 40a may control the prime mover E as the control target by using the rotational frequency detected by the rotational frequency sensor 43 instead of using the speed detected by the water vehicle speed sensor 42. For example, when the control mode is the towing mode, the CPU 40a may generate the second command value such that the rotational frequency detected by the rotational frequency sensor 43 becomes lower than a predetermined maximum rotational frequency set for a case where the control mode is the non-towing mode. When the control mode is the non-towing mode, the CPU 40a may generate the first command value such that the rotational frequency detected by the rotational frequency sensor 43 is allowed to exceed the predetermined rotational frequency. Moreover, when the control mode is the towing mode, the CPU 40a may generate the second command value such that the rotational frequency detected by the rotational frequency sensor 43 becomes lower than the predetermined rotational frequency. Even in this case, when the control mode of the water vehicle is the towing mode, the speed of the water vehicle can be made lower than that in the non-towing mode.

Moreover, the memory 40b may store a map of the command values corresponding to the requested values. When the control mode is the non-towing mode, the CPU 40a may generate, as the first command value based on the requested value, a command value corresponding to the requested value in the map. When the control mode is the towing mode, the CPU 40a may generate, as the second command value based on the requested value, a value obtained by correcting the command value corresponding to the requested value in the map such that the obtained value becomes smaller than the command value corresponding to the requested value in the map. In this case, for example, when the control mode is the towing mode, the CPU 40a may generate, as the second command value based on the requested value, a value obtained by multiplying the command value corresponding to the requested value in the map by a predetermined correction coefficient such that the obtained value becomes smaller than the command value corresponding to the requested value in the map. As above, the map used to acquire the first command value can be used to acquire the second command value.

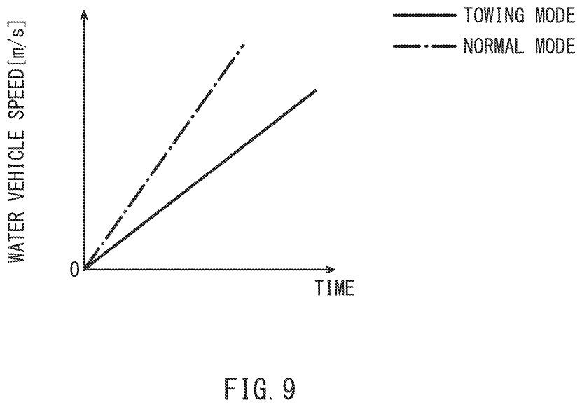

Moreover, a parameter different from the maximum speed in the towing mode may be made lower than that in the normal mode. For example, in the towing mode, the CPU 40a may generate the second command value such that the acceleration of the PWC 1 becomes lower than the acceleration when the control mode is the non-towing mode. This will be described with reference to FIG. 9.

FIG. 9 is a graph for explaining the towing traveling processing different from the processing shown in FIG. 6. FIG. 9 is a graph showing a change in water vehicle speed in the normal mode and a change in water vehicle speed in the towing mode. Specifically, FIG. 9 shows a relation between an elapsed time and the water vehicle speed when the rider 3a operates the accelerator lever 32 to, for example, an upper limit with the PWC 1 in a stop state and maintains such operation. To be specific, FIG. 9 shows the change in water vehicle speed in the normal mode and the change in water vehicle speed in the towing mode when the operation amount of the accelerator lever 32 is the same between the normal mode and the towing mode. In FIG. 9, the change in water vehicle speed in the normal mode is shown by a one-dot chain line, and the change in water vehicle speed in the towing mode is shown by a solid line.

As shown in FIG. 9, the inclination of the graph in the normal mode and the inclination of the graph in the towing mode are different from each other. To be specific, the acceleration that is the increase rate of the water vehicle speed with respect to the same detected value detected by the accelerator sensor 41, i.e., the same requested value is different between the normal mode and the towing mode. The acceleration with respect to a certain requested value in the towing mode is lower than the acceleration with respect to the same certain requested value in the normal mode.

To be specific, in the towing mode, the CPU 40a generates the second command value such that the acceleration of the PWC 1 becomes lower than the acceleration when the control mode is the non-towing mode. Therefore, the acceleration of the PWC 1 in the towing mode is made lower than that in the normal mode.

In the present embodiment, the reduced amount of the second command value from the first command value, in other words, a difference between the command values which corresponds to a difference between the acceleration in the normal mode and the acceleration in the towing mode may correspond to the type of the towing selected in Step S2. The memory 40b may store the accelerations suitable for the respective types of the towing, such as recreational boating, wakeboarding, and parasailing.

The mode in which the reduced amount of the second command value from the first command value is changed in accordance with the type of the towing selected in Step S2 is one example of the mode in which the reduced amount of the second command value from the first command value is changed in accordance with the operation of the rider 3a with respect to the user input interface. For example, in Step S2, instead of the type of the towing, towing skill of the towed person 4 included in the towed target may be selectable. The reduced amount of the second command value from the first command value may be determined in accordance with the towing skill. With this, traveling control corresponding to the towing skill of the person included in the towed target is realized. Moreover, for example, Step S2 may be omitted.

Depending on the type of the towing, it may be undesirable for the water vehicle body 11 to turn steeply during traveling. Therefore, control of suppressing such steep turn of the water vehicle body 11 may be performed in the towing mode. The steep turn of the water vehicle body 11 occurs in a case where the output of the prime mover E when the turning operation is performed with respect to the handle 31 is high output. Therefore, for example, the steering sensor may detect the turning operation for turning the water vehicle body by the rider 3a, and when the control mode is the towing mode, and the steering sensor detects the turning operation, the CPU 40a may generate based on the acquired requested value the second command value different from the first command value generated when the control mode is the non-towing mode, and may output the second command value to the prime mover E.

### Embodiment 2

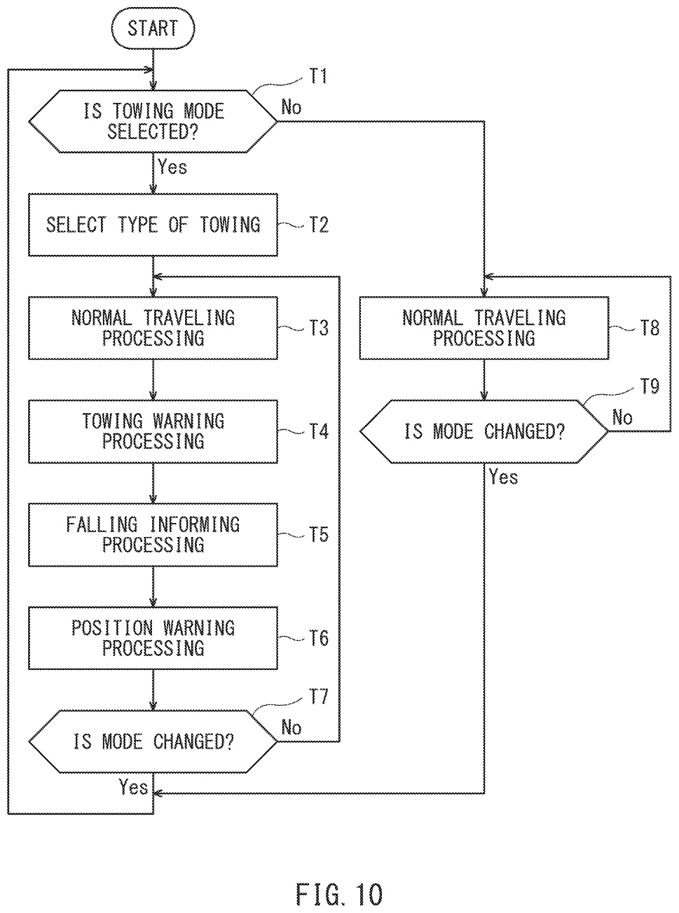

FIG. 10 is a flowchart for explaining operation processing of the controller 40 in the PWC 1 according to Embodiment 2. The configuration of the PWC 1 in the present embodiment is the same as that in Embodiment 1. The operation processing of the controller 40 in Embodiment 2 is different from that in Embodiment 1. Moreover, regarding the control method in the present embodiment, Steps T1, T2, T5, T6, T7, T8, and T9 in FIG. 10 are respectively the same as Steps S1, S2, S4, S5, S6, S7, and S8 in FIG. 5 of Embodiment 1. Therefore, the same explanations regarding Steps T1, T2, T5, T6, T7, T8, and T9 are omitted, and Steps T3 and T4 will be mainly described.

In the present embodiment, the control method of the prime mover E as the control target is the same between the normal mode and the towing mode. To be specific, when the CPU 40a determines that the towing mode is not selected (No in Step T1), and the type of the towing is selected and determined (Step T2), the same normal traveling processing as in the normal mode is executed as with Step T8 (Step T3).

Moreover, in the present embodiment, when the CPU 40a determines that the towing mode is not selected (No in Step T1), and the type of the towing is selected and determined (Step T2), towing warning processing is executed (Step T4).

In the towing warning processing, the CPU 40a determines whether or not a traveling state of the PWC 1 satisfies a predetermined warning condition with respect to the towing. When the CPU 40a determines that the warning condition is satisfied, the CPU 40a outputs predetermined warning information. The traveling state of the PWC 1 is detected by at least one traveling state detection sensor mounted on the water vehicle body 11.

The warning condition may be a condition in which the speed of the PWC 1 has exceeded a predetermined set speed. In this case, the traveling state detection sensor may be, for example, the water vehicle speed sensor 42. With this, the CPU 40a can inform the rider 3a that the water vehicle speed during the towing is excessive, and can urge the rider 3a to reduce the speed.

The warning condition may be a condition in which the rotational frequency of the prime mover E has exceeded a predetermined set rotational frequency. In this case, the traveling state detection sensor may be the rotational frequency sensor that detects the rotational frequency of the prime mover E. With this, the CPU 40a can inform the rider 3a that the output of the prime mover E during the towing is excessive, and can urge the rider 3a to reduce the output of the prime mover E.

The warning condition may be a condition in which the steering angle of the handle 31 has exceeded a predetermined angular range. In this case, the traveling state detection sensor may be the steering sensor 44. With this, the CPU 40a can inform the rider 3a that, for example, the steering angle by the turning operation is unsuitable for the towing, and can urge the rider 3a to suppress a steering range to a range suitable for the towing.

The warning condition may be a condition regarding a parameter other than the water vehicle speed, the rotational frequency of the prime mover E, and the steering amount. The warning condition may be a condition regarding a combined value calculated from two or more out of the water vehicle speed, the rotational frequency of the prime mover E, and the steering amount. The traveling state detection sensor may be the accelerator sensor 41, the water vehicle speed sensor 42, the engine rotational frequency sensor 43, the steering sensor 44, the position sensor 45, or a combination of two or more of these.

The warning information is output through both the display 33 and the speaker 34. However, the warning information may be output through the display 33 or the speaker 34. For example, the warning information is information that informs the rider 3a that the speed of the PWC 1 is within a speed region unsuitable for the towing, i.e., the speed of the PWC 1 is the set speed or more. The mode of the output of the warning information is not especially limited and may be such a mode that the rider 3a can recognize that the speed of the PWC 1 is within the speed region unsuitable for the towing. For example, the warning information displayed on the display 33 may be displayed as information including blinking, color change, enlargement, brightness change, text addition, mark addition, or any combination thereof. For example, the warning information output from the speaker 34 may be a voice message indicating that the warning condition has been satisfied or may be a buzzer sound.

In the present embodiment, outputting the warning information can urge the rider 3a to perform operation suitable for the towing. Therefore, traveling suitable for the towing can be realized without changing the control method of the control target between the normal mode and the towing mode. However, in the present embodiment, the control method of the control target may be changed between the normal mode and the towing mode. For example, in Step T3, the towing traveling processing (see Step S3 in FIG. 5) may be performed as with Embodiment 1.

### OTHER EMBODIMENTS

The present disclosure is not limited to the above-described embodiments, and various modifications may be made within the scope of the present disclosure.

The configuration of the above embodiment is applicable to water vehicles other than the personal watercraft. The configuration of the above embodiment is applicable to a power boat including a prime mover as a traveling driving source.

In the above embodiment, the control mode is switched between the towing mode and the non-towing mode by the operation of the user with respect to the user interface. However, the selection of the control mode may be automatically executed. For example, the water vehicle may include a tow sensor that detects whether or not the water vehicle is towing the towed target. In this case, the CPU may switch the control mode between the towing mode and the non-towing mode based on information detected by the tow sensor.

For example, the tow sensor may directly or indirectly detect whether or not the water vehicle is towing the towed target. For example, as in the above embodiment, when the fixture, such as the pole, which is necessary for the towing is attachable to and detachable from the water vehicle body, the tow sensor may be a sensor that detects that the pole is being attached to the water vehicle body. When the fixture, such as the pole, which is necessary for the towing can horizontally fall down or can retract in the water vehicle body when the towing is not being performed, the tow sensor may be a sensor that detects the posture or position of the fixture when the towing is not being performed. For example, the tow sensor may be an object detection sensor, an infrared sensor, an image sensor, a contact sensor, or the like. As in the above embodiment, in a case where the pole is in the contracted state when the towing is not performed, and is in the extended state when the towing is performed, the tow sensor may detect the extended state or contracted state of the pole.

In the above embodiment, the control target that is controlled to operate the water vehicle body, i.e., the control target that is a destination to which the command value is output is the internal combustion engine that is the traveling driving source. However, the prime mover that is the traveling driving source as the control target may be an internal combustion engine, an electric motor, or a combination of the internal combustion engine and the electric motor.

Moreover, the control target does not have to be the traveling driving source. For example, in a water vehicle in which the direction of the steering nozzle can be changed by an actuator that is controlled in accordance with a handle operation of the rider 3a, the control target that is the destination to which the command value is output may be the actuator that changes the direction of the steering nozzle. For example, the control target may be an actuator that changes the position of the reverse bucket. Moreover, for example, when the water vehicle includes a trim nozzle that changes the trim of the water vehicle, i.e., the inclination of the water vehicle in a pitching direction, and further includes an actuator that changes the direction of the trim nozzle, the control target that is the destination to which the command value is output may be the actuator that changes the direction of the trim nozzle. The control target may be a control target that is controlled in the towing mode by the control method that is different from the control method in the normal mode.

In Embodiment 1 described above, since the control target is the traveling driving source, the requested value used to operate the water vehicle body is the value acquired from the accelerator sensor. However, the method of acquiring the requested value used to operate the water vehicle body changes depending on the type of the control target. For example, the requested value used to operate the water vehicle body may be the value detected by the steering angle sensor.

The fixture to which one end portion of the extending structure used to tow the towed target is fixed is the pole. However, the fixture is not limited to this. The fixture may be a bar-shaped, hook-shaped, or annular fixing metal fitting to which one end portion of the extending structure can be fixed. The height of the upper end of the fixture may be lower than the height of the uppermost surface of the seat.

The extending structure used to tow the towed target may be a string-shaped body, a band-shaped body, or a rod-shaped body. The material of the extending structure may be natural fiber, synthetic fiber, metal fiber, rubber, metal, resin, plastic, or the like. For example, the extending structure may be a fiber rope, a rubber rope, or a belt.

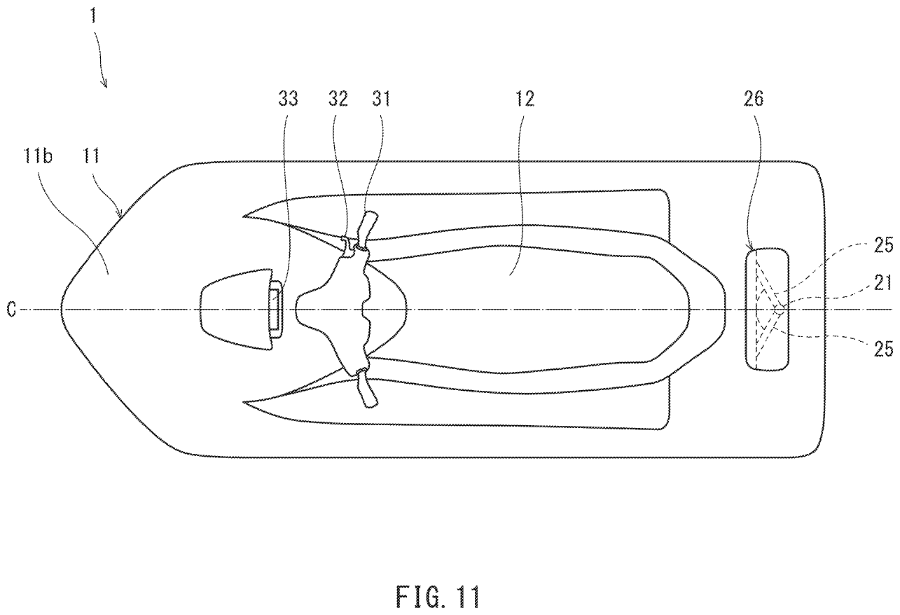

The position, shape, configuration of the cover that covers the fixture, the method of supporting the cover, and the like are not limited to those described in the above embodiments. For example, in a top view, the cover may have a substantially square shape. To be specific, in a top view, the front plate portion of the cover main body has a circular-arc shape. However, in a top view, the front plate portion of the cover main body may have a linear shape extending in the left-right direction, like a cover 26 shown in FIG. 11. The cover may be integrated with the seat on which the rider of the water vehicle is seated. In this case, the cover may function as a backrest.

Moreover, the cover may cover a part of the fixture or only a front side of the entire fixture. In a front view of the PWC, the cover may overlap the entire pole, not only the upper end portion of the pole. Moreover, in a top view of the PWC, the cover does not have to overlap the pole. When the PWC is viewed in the left-right direction, the cover may overlap the pole. The pad may be located only at the front plate portion of the cover main body. The cover does not have to include the pad.

Moreover, the controller 40 does not have to execute the operation processing described in Embodiments 1 and 2.

The functionality of the elements disclosed herein may be implemented using circuitry or processing circuitry which includes general purpose processors, special purpose processors, integrated circuits, ASICs (“Application Specific Integrated Circuits”), conventional circuitry or combinations thereof which are configured or programmed to perform the disclosed functionality. Processors are considered processing circuitry or circuitry as they include transistors and other circuitry therein. The processor may be a programmed processor which executes a program stored in a memory. In the disclosure, the circuitry, units, or means are hardware that carry out or are programmed to perform the recited functionality. The hardware may be any hardware disclosed herein or otherwise known which is programmed or configured to carry out the recited functionality. When the hardware is a processor which may be considered a type of circuitry, the circuitry, means, or units are a combination of hardware and software, the software being used to configure the hardware or processor.

Moreover, various programs disclosed in the present specification are stored in a storage. The storage is a device which is incorporated in or externally attached to a computer and is readable and writable or readable. For example, the storage may be a hard disk, a flash memory, an optical disk, or the like. The program stored in the storage may be executed by a computer to which the storage is directly connected or may be downloaded to and executed by a computer connected to the storage through a network (for example, the Internet).

### Disclosed Aspects

The following aspects disclose preferred embodiments.

### First Aspect

A water vehicle including:
a water vehicle body;
a control target mounted on the water vehicle body and controlled to operate the water vehicle body; and
processing circuitry configured to acquire requested values used to operate the water vehicle body and generate, based on the requested values, command values to be output to the control target, wherein:
the processing circuitry switches a control mode between a towing mode in which the water vehicle tows a towed target and a non-towing mode in which the water vehicle does not tow the towed target; and when the control mode is the towing mode, the processing circuitry generates, based on the requested value, a second command value that is the command value different from a first command value that is the command value generated based on the requested value when the control mode is the non-towing mode.

When the water vehicle tows a wakeboard, play equipment such as a recreational boat, or the like, the water vehicle is desired to perform traveling suitable for the towing. According to the above aspect, the water vehicle can be controlled so as to perform operation suitable for the towing.

### Second Aspect

The water vehicle according to the first aspect, wherein the processing circuitry generates the second command value such that a maximum speed of the water vehicle when the control mode is the towing mode becomes lower than a maximum speed of the water vehicle when the control mode is the non-towing mode.

According to the above aspect, when the control mode of the water vehicle is the towing mode, the speed of the water vehicle can be reduced.

### Third Aspect

The water vehicle according to the first aspect, further including a rotational frequency sensor that detects a rotational frequency of a traveling driving source of the water vehicle body, wherein when the control mode is the towing mode, the processing circuitry generates the second command value such that the rotational frequency detected by the rotational frequency sensor becomes lower than a predetermined maximum rotational frequency set for a case where the control mode is the non-towing mode.

According to the above aspect, when the control mode of the water vehicle is the towing mode, the speed of the water vehicle can be reduced.

### Fourth Aspect

The water vehicle according to the first aspect, further including a memory storing a map showing the command values corresponding to the requested values, wherein:
when the control mode is the non-towing mode, the processing circuitry generates, as the first command value based on the requested value, the command value corresponding to the requested value in the map; and
when the control mode is the towing mode, the processing circuitry generates, as the second command value based on the requested value, a value obtained by correcting the command value corresponding to the requested value in the map such that the obtained value becomes smaller than the command value corresponding to the requested value in the map.

According to the above aspect, the map used to acquire the first command value can be used to acquire the second command value.

### Fifth Aspect

The water vehicle according to any one of the first to fourth aspects, further including a tow sensor that detects whether or not the water vehicle is towing the towed target, wherein the processing circuitry switches the control mode between the towing mode and the non-towing mode based on information detected by the tow sensor.

According to the above aspect, switching between the towing mode and the non-towing mode can be automatically performed.

### Sixth Aspect

The water vehicle according to any one of the first to fifth aspects, further including a user input interface that receives operation of a rider, wherein
the processing circuitry switches the control mode between the towing mode and the non-towing mode in accordance with the operation of the rider with respect to the user input interface.

According to the above aspect, the rider can manually and freely select switching between the towing mode and the non-towing mode.

### Seventh Aspect

The water vehicle according to any one of the first to sixth aspects, further including a water vehicle communicator that communicates with a target communicator attached to the towed target, wherein
the processing circuitry determines a towed state of the towed target based on a signal received from the target communicator by the water vehicle communicator or based on a communication state between the water vehicle communicator and the target communicator.

According to the above aspect, control when the towed target is not being towed any more is easily executed.

### Eighth Aspect

The water vehicle according to any one of the first to seventh aspects, further including an informer mounted on the water vehicle body, wherein
when the processing circuitry determines that the towed target is not being towed any more, the processing circuitry outputs a determination result through the informer.

According to the above aspect, it is possible to quickly inform the rider that the towed target is not being towed any more.

### Ninth Aspect

The water vehicle according to any one of the first to eighth aspects, further including:
a fixture which extends upward from the water vehicle body and to which one end portion of an extending structure used to tow the towed target is fixed; and
a seat which is located in front of the fixture and on which a rider is seated, wherein
a height of an upper end of the fixture is higher than a height of an uppermost surface of the seat.

According to the above aspect, the extending structure can be extended from the fixture at a position above the seat. Therefore, the extending structure can be extended from a position suitable for water sports and sky sports.

### Tenth Aspect

The water vehicle according to the ninth aspect, further including a cover located behind the seat and covering at least a part of the fixture from a front side.

According to the above aspect, at least a part of the fixture can be protected.

### Eleventh Aspect

The water vehicle according to the tenth aspect, wherein the cover includes:
a cover main body supported by the water vehicle body; and
a pad located on a surface of the cover main body, the surface facing forward.

According to the above aspect, impact generated when an object or a person collides with the cover can be absorbed by the pad.

### Twelfth Aspect

The water vehicle according to any one of the first to eleventh aspects, further including a user input interface that receives operation of a rider, wherein
the processing circuitry changes a reduced amount of the second command value from the first command value in accordance with the operation of the rider with respect to the user input interface.

According to the above aspect, the operation of the water vehicle in the towing mode can be set to operation desired by the user.

### Thirteenth Aspect

The water vehicle according to any one of the first to twelfth aspects, further including a steering sensor that detects turning operation of turning the water vehicle body by a rider, wherein:
the control target is a traveling driving source that generates driving power by which the water vehicle body travels; and
when the control mode is the towing mode, and the steering sensor detects the turning operation, the processing circuitry generates the second command value different from the first command value, based on the requested value.

According to the above aspect, steep turn of the water vehicle body that is traveling in the towing mode can be suppressed.

### Fourteenth Aspect

The water vehicle according to any one of the first to thirteenth aspects, further including:
a position sensor that detects a geographical position of the water vehicle body; and an informer, wherein:
when the control mode is the towing mode, the processing circuitry determines based on the position detected by the position sensor whether or not the water vehicle body is located within a predetermined warning region; and
when the processing circuitry determines that the water vehicle body is located within the warning region, the processing circuitry outputs predetermined warning information through the informer.

According to the above aspect, it is possible to quickly inform the rider that the water vehicle body is located in, for example, a region where towing sports and towing activities are inhibited or a region where attention is necessary.

### Fifteenth Aspect

The water vehicle according to the first aspect, further including a water vehicle speed sensor that detects a speed of the water vehicle, wherein:
the control target is a traveling driving source that generates driving power by which the water vehicle body travels; and
when the control mode is the towing mode, the processing circuitry generates the second command value such that the speed detected by the water vehicle speed sensor becomes a predetermined speed or less.

According to the above aspect, when the control mode of the water vehicle is the towing mode, the speed of the water vehicle can be reduced.

### Sixteenth Aspect

The water vehicle according to the first aspect, further including a rotational frequency sensor that detects a rotational frequency of a traveling driving source of the water vehicle body, wherein
when the control mode is the towing mode, the processing circuitry generates the second command value such that the rotational frequency detected by the rotational frequency sensor becomes lower than a predetermined rotational frequency.

According to the above aspect, when the control mode of the water vehicle is the towing mode, the speed of the water vehicle can be reduced.

### Seventeenth Aspect

A water vehicle including:
a water vehicle body;
a fixture which extends upward from the water vehicle body and to which one end portion of an extending structure used to tow the towed target is fixed; and
a seat which is located in front of the fixture and on which a rider is seated, wherein
a height of an upper end of the fixture is higher than a height of an uppermost surface of the seat.

According to the above aspect, the extending structure can be extended from the fixture at a position above the seat. Therefore, the extending structure can be extended from a position suitable for water sports and sky sports.

### Eighteenth Aspect

A water vehicle including:
a water vehicle body;
a traveling state detection sensor that detects a traveling state of the water vehicle;
an informer mounted on the water vehicle body; and
processing circuitry configured to control the informer, wherein:
the processing circuitry switches a control mode between a towing mode in which the water vehicle tows a towed target and a non-towing mode in which the water vehicle does not tow the towed target;
when the control mode is the towing mode, the processing circuitry determines whether or not the traveling state detected by the traveling state detection sensor satisfies a predetermined warning condition; and
when the processing circuitry determines that the warning condition is satisfied, the processing circuitry outputs predetermined warning information through the informer.

According to the above aspect, when the control mode is the towing mode, and a traveling condition of the water vehicle exceeds a predetermined value, the informer is made to output a warning. Therefore, the rider can be urged to travel at a speed suitable for the towing.

Moreover, the following configuration also discloses a preferred embodiment.

### First Configuration

A water vehicle including:
a water vehicle body;
a water vehicle communicator that is located at the water vehicle body and communicates with a target communicator attached to a towed target towed by the water vehicle body; and
processing circuitry connected to the water vehicle communicator, wherein
the processing circuitry determines a towed state of the towed target based on a signal received from the target communicator by the water vehicle communicator or based on a communication state between the water vehicle communicator and the target communicator.

According to the above configuration, the determination of the towed state of the towed target is easy. Moreover, the determination result is easily utilized. For example, the determination result is utilized for control or is informed to the rider of the water vehicle. The towed state of the towed target may relate to whether or not the towed target is being towed.

As described above, the embodiment has been described as an example of the technology disclosed in the present application. However, the technology in the present disclosure is not limited to this and is also applicable to embodiments in which modifications, replacements, additions, omissions, and the like are suitably made. Moreover, a new embodiment may be prepared by combining the components described in the above embodiment. For example, some of components or methods in one embodiment may be applied to another embodiment. Some components in an embodiment may be separated and arbitrarily extracted from the other components in the embodiment. Furthermore, the components shown in the attached drawings and the detailed explanations include not only components essential to solve the problems but also components for exemplifying the above technology and not essential to solve the problems.

What is claimed is:

1. A water vehicle comprising:
a water vehicle body;
a control target mounted on the water vehicle body and controlled to operate the water vehicle body; and
processing circuitry configured to acquire requested values used to operate the water vehicle body and generate, based on the requested values, command values to be output to the control target, wherein:
the processing circuitry switches a control mode between a towing mode in which the water vehicle tows a towed target and a non-towing mode in which the water vehicle does not tow the towed target; and
when the control mode is the towing mode, the processing circuitry generates, based on the requested value, a second command value that is the command value different from a first command value that is the command value generated based on the requested value when the control mode is the non-towing mode.

2. The water vehicle according to claim 1, wherein the processing circuitry generates the second command value such that a maximum speed of the water vehicle when the control mode is the towing mode becomes lower than a maximum speed of the water vehicle when the control mode is the non-towing mode.

3. The water vehicle according to claim 1, further comprising a rotational frequency sensor that detects a rotational frequency of a traveling driving source of the water vehicle body, wherein
when the control mode is the towing mode, the processing circuitry generates the second command value such that the rotational frequency detected by the rotational frequency sensor becomes lower than a predetermined maximum rotational frequency set for a case where the control mode is the non-towing mode.

4. The water vehicle according to claim 1, further comprising a memory storing a map showing the command values corresponding to the requested values, wherein:
when the control mode is the non-towing mode, the processing circuitry generates, as the first command value based on the requested value, the command value corresponding to the requested value in the map; and
when the control mode is the towing mode, the processing circuitry generates, as the second command value based on the requested value, a value obtained by correcting the command value corresponding to the requested value in the map such that the obtained value becomes smaller than the command value corresponding to the requested value in the map.

5. The water vehicle according to claim 1, further comprising a tow sensor that detects whether or not the water vehicle is towing the towed target, wherein
the processing circuitry switches the control mode between the towing mode and the non-towing mode based on information detected by the tow sensor.

6. The water vehicle according to claim 1, further comprising a user input interface that receives operation of a rider, wherein
the processing circuitry switches the control mode between the towing mode and the non-towing mode in accordance with the operation of the rider with respect to the user input interface.

7. The water vehicle according to claim 1, further comprising a water vehicle communicator that communicates with a target communicator attached to the towed target, wherein
the processing circuitry determines a towed state of the towed target based on a signal received from the target communicator by the water vehicle communicator or based on a communication state between the water vehicle communicator and the target communicator.

8. The water vehicle according to claim 1, further comprising an informer mounted on the water vehicle body, wherein
when the processing circuitry determines that the towed target is not being towed any more, the processing circuitry outputs a determination result through the informer.

9. The water vehicle according to claim 1, further comprising:
a fixture which extends upward from the water vehicle body and to which one end portion of an extending structure used to tow the towed target is fixed; and
a seat which is located in front of the fixture and on which a rider is seated, wherein
a height of an upper end of the fixture is higher than a height of an uppermost surface of the seat.

10. The water vehicle according to claim 9, further comprising a cover located behind the seat and covering at least a part of the fixture from a front side.

11. The water vehicle according to claim 10, wherein the cover includes:
a cover main body supported by the water vehicle body; and
a pad located on a surface of the cover main body, the surface facing forward.

12. The water vehicle according to claim 1, further comprising a user input interface that receives operation of a rider, wherein
the processing circuitry changes a reduced amount of the second command value from the first command value in accordance with the operation of the rider with respect to the user input interface.

13. The water vehicle according to claim 1, further comprising a steering sensor that detects turning operation of turning the water vehicle body by a rider, wherein:
the control target is a traveling driving source that generates driving power by which the water vehicle body travels; and
when the control mode is the towing mode, and the steering sensor detects the turning operation, the processing circuitry generates the second command value different from the first command value, based on the requested value.

14. The water vehicle according to claim 1, further comprising:
a position sensor that detects a geographical position of the water vehicle body; and
an informer, wherein:
when the control mode is the towing mode, the processing circuitry determines based on the position detected by the position sensor whether or not the water vehicle body is located within a predetermined warning region; and
when the processing circuitry determines that the water vehicle body is located within the warning region, the processing circuitry outputs predetermined warning information through the informer.

15. The water vehicle according to claim 1, further comprising a water vehicle speed sensor that detects a speed of the water vehicle, wherein:
the control target is a traveling driving source that generates driving power by which the water vehicle body travels; and
when the control mode is the towing mode, the processing circuitry generates the second command value such that the speed detected by the water vehicle speed sensor becomes a predetermined speed or less.

16. The water vehicle according to claim 1, further comprising a rotational frequency sensor that detects a rotational frequency of a traveling driving source of the water vehicle body, wherein
when the control mode is the towing mode, the processing circuitry generates the second command value such that the rotational frequency detected by the rotational frequency sensor becomes lower than a predetermined rotational frequency.

17. A water vehicle comprising:
a water vehicle body;
a fixture which extends upward from the water vehicle body and to which one end portion of an extending structure used to tow the towed target is fixed; and
a seat which is located in front of the fixture and on which a rider is seated, wherein
a height of an upper end of the fixture is higher than a height of an uppermost surface of the seat.

18. A water vehicle comprising:
a water vehicle body;
a traveling state detection sensor that detects a traveling state of the water vehicle;
an informer mounted on the water vehicle body; and
processing circuitry configured to control the informer, wherein:
the processing circuitry switches a control mode between a towing mode in which the water vehicle tows a towed target and a non-towing mode in which the water vehicle does not tow the towed target;
when the control mode is the towing mode, the processing circuitry determines whether or not the traveling state detected by the traveling state detection sensor satisfies a predetermined warning condition; and
when the processing circuitry determines that the warning condition is satisfied, the processing circuitry outputs predetermined warning information through the informer.
